(19) United States
(12) Patent Application Publication
(10) Pub. No.: US 2003/0154823 A1
(43) Pub. Date: Aug. 21, 2003

(54) Device for widening strap clips

(76) Inventor: Horst Klann, Villingen-Schwenningen (DE)

Correspondence Address: McGLEW AND TUTTLE, P.C., SCARBOROUGH STATION, SCARBOROUGH, NY, 10510-0827, US

(21) Appl. No.: 10/370,300

(22) Filed: Feb. 18, 2003

(30) Foreign Application Priority Data
Feb. 21, 2002 (DE) 202 02 705.8

(51) Int. Cl. B25B 27/10

(52) U.S. Cl. 81/9.3

(57) ABSTRACT

A device for widening strap clips (16) includes two clamping jaws (1/3, 1/4), which are arranged opposite each other in a common path of movement and the distance between which can be changed for widening a strap clip (16). The clamping jaws (1/3, 1/4) can be brought into engagement with each radially projecting clamping tongue (21, 22, 23) of the strap clip (16). To prevent damage to the strap clip (16), provisions are made for the clamping jaws (1/3, 1/4) to each have in the area of their faces (2/3, 2/4) facing each other a receiving groove (3/3, 3/4). The receiving groove receives the free end of the respective clamping tongue (21, 22, 23) and has a limiting web (5/3, 5/4) located toward the strap clip (16) extending behind the particular clamping tongue (21, 22, 23) during widening and points, located approximately in parallel to the path of movement, toward the clamping tongue (21, 22, 23). A height (H) of the limiting web (5/3, 5/4) is selected to be so small that the particular clamping tongue (21, 22, 23) is supported at the bottom (27/3, 27/4) of the receiving groove (3/3, 3/4) at least at the beginning of the clamping operation during the widening of the strap clip (16).

### FIELD OF THE INVENTION

The present invention pertains to a device for widening strap clips, comprising clamping jaws, which are arranged, located opposite each other, in a common path of movement and the distance between which can be changed for widening the strap clip, wherein the clamping jaws can be brought into engagement with a radially projecting clamping tongue each of the strap clip and point, located approximately in parallel to the path of movement, toward the clamping tongue.

### BACKGROUND OF THE INVENTION

Devices of this class have been known, e.g., from DE 44 18 763 C1 as well as DE 44 40 210 A1.

A mounting tool for so-called strap clips, which has an extremely small overall size and is said to be able to be manufactured at low cost, is described in the subject of DE 44 18 763 C1. For the most universal use possible of this mounting tool, this tool has a first abutment, which is arranged stationarily on a guide rail. A housing is mounted in a longitudinally displaceable manner on this guide rail opposite this first abutment. This housing has a second abutment, whose distance from the first abutment can be changed during the longitudinal displacement of the housing along the guide rail. Two clamping tongues of a strap clip can be introduced into the intermediate space between the two abutments of this mounting tool. The two clamping tongues are now moved toward each other due to the reduction of the distance between the abutments, as a result of which widening of the strap clip is brought about. A kind of spindle drive is provided as an actuating means. This spindle drive comprises a conical threaded bolt, which engages with its external thread corresponding grooves of the guide rail, which are located one after another, so that the housing can be displaced axially along the guide rail during the rotation of this threaded bolt arranged in the housing. This mounting tool can be used exclusively for strap clips whose clamping tongues, projecting radially outwardly, project over the ring-shaped strap clip by at least 5 mm to 6 mm.

However, strap clips have also become known whose clamping tongues project radially only slightly to the outside from the strap clip. In particular, strap clips have also become known whose clamping tongues are located on a radially slightly larger circular path outside of the outer surface of the strap clip proper. Such clamping tongues cannot be gripped with the mounting tool according to DE 44 18 763 C1.

The subject of DE 44 40 210 A1 is so-called hose band clip tongs, which shall likewise be used to widen strap clips. These hose band clip tongs have for this purpose so-called tong jaws at the end of their tong legs, which are provided with wedge surfaces on their faces facing each other for receiving the clamping tongues. Two different forms of these tong jaws are shown. Reference is therefore made to the specification of DE 44 40 210 A1 especially in respect to the specific design of the tong jaws.

It was now found that these hose band clip tongs are also suitable essentially only for strap clips whose clamping tongues radially project outwardly beyond the strap clip proper by several mm. These hose band clip tongs are not suitable for strap clips with clamping tongues extending tangentially or in parallel to the surface of the strap clip especially because of the wedge surfaces of their tong jaws. This is due to the fact that during the clamping of tangentially extending clamping tongues of the strap clip, these are bent up radially outwardly, so that the entire strap clip is deformed during the widening. However, the necessary uniform clamping action cannot be guaranteed any longer, e.g., after placement on a hose connection, because the necessary pressing forces against the hose wall cannot be applied over the entire circumference.

### SUMMARY OF THE INVENTION

The basic object of the present invention is consequently to improve a device of this type such that it can also be reliably used for strap clips with clamping tongues extending tangentially or in the circumferential direction outside the strap clip proper, and not only for strap clips with radially outwardly projecting clamping tongues.

The object is accomplished according to the present invention with a device for widening strap clips comprising two clamping jaws arranged opposite each other in a common path of movement. The distance between these can be changed for widening the strap clip. The clamping jaws can be brought into engagement each with a radially projecting clamping tongue of the strap clip, by the clamping jaws having, in the area of their faces facing each other, a receiving groove, which receives the free end of the particular clamping tongue, and whose limiting web located toward the strap clip extends behind the particular clamping tongue during widening and points, located approximately in parallel to the path of movement, toward the clamping tongue, and that the height H of the limiting web is selected to be so small that the particular clamping tongue is supported at the bottom of the receiving groove at least at the beginning of the clamping operation during the widening of the strap clip.

The embodiment of the clamping jaws according to the present invention provides a device for widening strap clips, which can be used variably equally for strap clips with radially outwardly projecting clamping tongues as well as for strap clips with clamping tongues extending tangentially or with clamping tongues that are curved in the circumferential direction and extend on the outside in parallel to the strap clip.

The clamping jaws have for this purpose a receiving groove receiving the free end of the particular clamping tongue in the area of their faces facing each other, i.e., the free ends of the particular clamping tongue can be inserted into this mounting groove, regardless of whether the clamping tongue is arranged extending radially or tangentially or in parallel to the surface of the strap clip. Furthermore, the limiting web of the mounting groove located toward the strap clip extends the particular clamping tongue to be received during the widening of the strap clip. It is ensured by this shape that the two clamping jaws cannot slip off from the free end of the particular clamping tongue. Furthermore, the limiting web is located in parallel to the path of movement of the clamping jaws and points toward the particular clamping tongue received. Due to the selection of an extremely small height H of the limiting web, it is achieved with certainty that the particular clamping tongue is supported at the bottom of the receiving groove at least at the beginning of the clamping operation during the widening of the strap clip. It is achieved as a result that the particular clamping tongue is supported on the bottom of the groove essentially on the front side and is not bent unintentionally radially outwardly by the limiting web extending behind the clamping tongue. Radial deformation of the strap clip is thus reliably prevented from occurring at the beginning and also during the further course of the clamping operation.

According to a further aspect of the invention the limiting web extending behind the clamping tongue may be arranged set back in relation to the face of the particular clamping jaw. This embodiment makes possible especially the satisfactory widening of a strap clip with essentially radially extending clamping tongues. This embodiment prevents the clamping tongues from being pinched between the two clamping jaws in case of a complete clamping path. An undesired deformation of these clamping tongues is thus reliably prevented from occurring.

According to a further aspect of the invention, the receiving groove may be circularly limited, and the safety web of the receiving groove located opposite the limiting web may be located in the plane of the face of the clamping jaw. Especially in cooperation with the embodiment discussed immediately above, this embodiment reliably prevents the clamping tongues from being able to slip out of the receiving groove with increasing clamping path in the case of radially extending clamping tongues.

The width B of the receiving groove should not be greater than four times the thickness d1 of the clamping tongue to be received according to a further aspect of the invention. This embodiment guarantees the reliable receiving of the particular clamping tongue, whereas deformation of this clamping tongue because of changes in the angle of the clamping tongues during the widening of the strap clip is reliably ruled out during the clamping operation, because the clamping tongue is received in the receiving groove with sufficient clearance.

According to a further aspect of the invention that acts in a similar manner, the depth T of the receiving groove, measured from the front side of the particular clamping jaw, shall correspond at most to four times the thickness d1 of the clamping tongue to be received. If the depth T is greater, but also in case of a narrower design of the receiving groove, the clearance between the receiving groove and the clamping tongue would be too small, especially in the case of tangentially extending clamping tongues, to prevent the clamping tongue with certainty from being able to be deformed during the widening of the strap clip. Such a possibility of deformation is likewise ruled out because of this not very great depth T of the receiving groove.

Different embodiments of the entire device may be provided. The clamping jaw may be arranged in the end area of the tong legs of a clamping tongue. This corresponds essentially to an arrangement similar to the state of the art DE 44 40 210 A1 already mentioned. An embodiment may be provided that essentially corresponds to the embodiment according to the document DE 44 18 763 C1.

The clamping jaws according to the present invention can be used in an extremely variable manner with a great variety of actuating means to change the distance between the two clamping jaws. For example, a combination or use with a bowden cable system known from the state of the art may also be provided, for which the clamping jaws according to the present invention are best suited as well.

An exemplary embodiment of the present invention will be explained in greater detail below on the basis of the drawings. This exemplary embodiment shall illustrate only the general embodiment of the subject of the present invention. However, the present invention shall not be considered to be limited to this exemplary embodiment, but it also comprises all the combinations of features described in the claims. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a clamping jaw according to the present invention;

FIG. 2 is a vertical sectional view through the clamping jaw of FIG. 1;

FIG. 3 is a perspective view showing a strap clip with clamping tongues which project only minimally to the outside but not radially;

FIG. 4 is a perspective view showing a strap clip with radially outwardly projecting clamping tongues;

FIG. 5 is a top partially sectional view of the strap clip from FIG. 3 with two clamping jaws according to the present invention attached;

FIG. 6 is a top partially sectional view of the strap clip of FIG. 4 with two clamping jaws according to the present invention attached;

FIG. 7 is partially sectional view showing an exemplary embodiment of a device according to the present invention with two clamping jaws, which are adjustable in relation to one another by means of a spindle drive; and

FIG. 8 is a general view of a clamping tongue with two clamping jaws according to the present invention.

### DESCRIPTION OF THE PREFERRED EMBODIMENTS

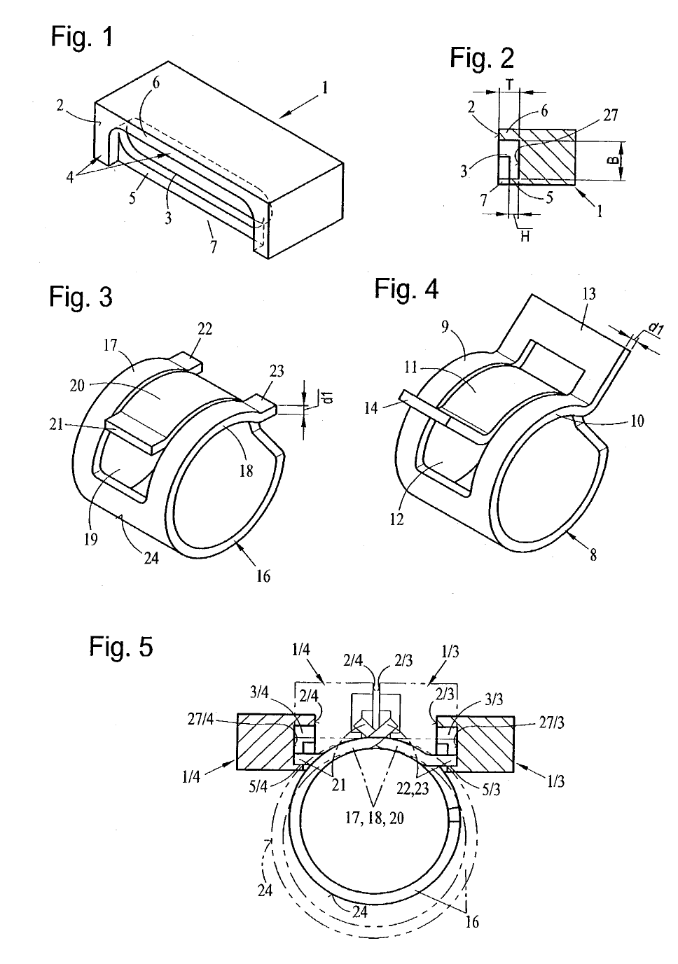

Referring to the drawings in particular, FIG. 1 shows an exemplary embodiment of a clamping jaw 1 according to the present invention, which has an approximmately parallelepipedic shape in this case. In the area of its face 2, the clamping jaw 1 is provided with a receiving groove 3, which has an essentially rectangular cross section in this exemplary embodiment and is limited on all sides by a circumferential edge web 4. This circumferential edge web 4 has a limiting web 5 set back in relation to the face 2 in the lower area. The safety web 6 located opposite this limiting web 5 is located in a common plane together with the face 2 of the clamping jaw 1. Because of the offset arrangement of the limiting web 5 in relation to the face 2, an opening 7 is formed in this area.

This shape of the receiving groove 3 can be seen especially clearly in FIG. 2, which shows a vertical section of the clamping jaw 1 from FIG. 1. When the clamping jaw 1 is used, the receiving groove 3 is used to receive a clamping tongue of a strap clip to be widened, as is shown, e.g., in FIGS. 3 and 4. It can be recognized that the limiting web 5 has an extremely small height H relative to the groove bottom 27 and is arranged set back in relation to the face 2.

Furthermore, the overall depth T of the receiving groove 3 measured from the face 2 is likewise not very great and should correspond at most to four times the thickness or wall thickness d1 of a strap clip, as is shown as an example in FIGS. 3 and 4. The width B of the receiving groove 3 should not be greater than four times the thickness d1 of a strap clip or of its clamping tongue, either, in order to prevent the clamping tongue from being bent during the widening of the strap clip.

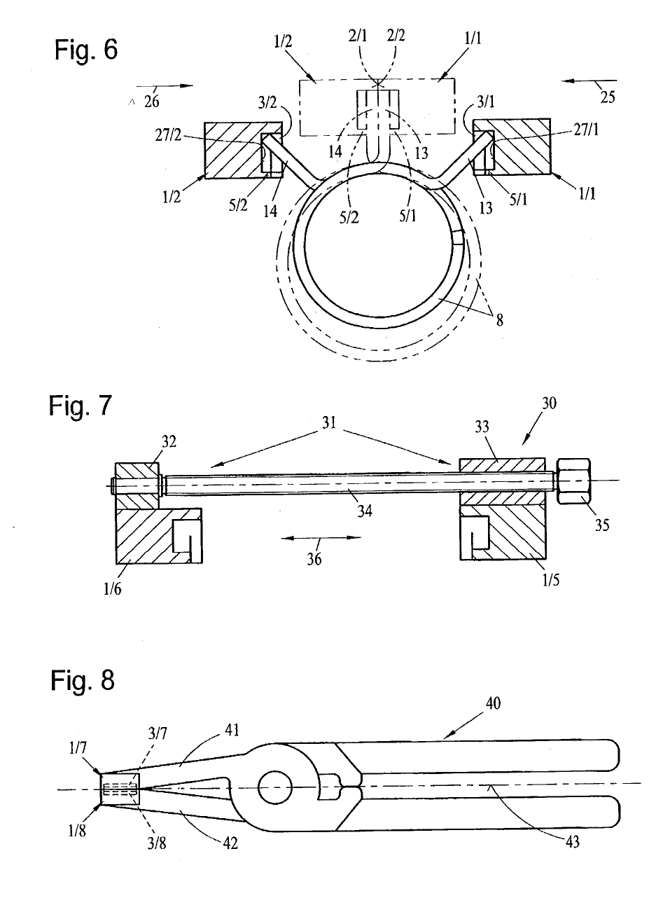

Furthermore, two clamping jaws 1 each, which will be explained in greater detail below in connection with FIGS. 5 and 6, are provided for widening a strap clip.

FIG. 3 shows a prior-art embodiment of a strap clip 16, which likewise forms a kind of clamping ring and is shown in its neutral state in FIG. 3. This strap clip 16 also has two outer overlapping sections 17 and 18, which likewise form a receiving slot 19 between them. An inner overlapping section 20 of the strap clip is received in this receiving slot, so that the strap clip 16 also forms essentially a round inner contour. A clamping tongue 21 is likewise arranged at the free end of the inner overlapping section 20, but this clamping tongue 21 does not extend radially, but it extends to a tangential plane passing through to the overlapping section 20 in the connection area of the clamping tongue 21 at an angle of about 45°.

Another clamping tongue 22 and 23 is provided at the respective free ends of the overlapping sections 17 and 18, and these clamping tongues 17 and 18 likewise do not extend radially to the strap clip 16 but they extend at 45° to a tangential plane, which passes through the connection area of these two clamping tongues 22 and 23 to the corresponding overlapping sections 17 and 18.

FIG. 4 shows another prior-art embodiment of a strap clip 8, which has a circular ring-shaped design. It can be recognized in FIG. 3 that the strap clip 8 has two outer overlapping sections 9 and 10 as well as an inner overlapping section 11 in its upper area. The two outer overlapping sections 9 and 10 form a receiving slot 12, into which extends the inner overlapping section 11 of the strap clip 8. This receiving slot 12 continues in a clamping tongue 13, which, extending radially to the strap clip 8, is arranged at the free ends of the two overlapping sections 9 and 10. By contrast, a second clamping tongue 14, which is arranged at about 90° to the first clamping tongue 13 of the strap clip 8, positioned radially outwardly, in the unclamped, neutral state of the strap clip, is provided at the free end of the inner overlapping section 11.

Such strap clips 8 and 16, as are shown as examples in FIGS. 3 and 4, have been sufficiently known from the state of the art. Also known are strap clips that also have short tongue sections extending in an arc-shaped pattern in the circumferential direction adjoining the clamping tongues 21, 22, 23, located outside the outer jacket surface 24 of the strap clip 16.

Such prior-art strap clips 8 and 16 can be widened with certainty with the clamping jaw 1 according to the present invention as shown in FIGS. 1 and 2 without these strap clips 8 and 16 being deformed. Two clamping jaws 1/1 and 1/2 or 1/3 and 1/4 are needed to widen these strap clips 8 and 16, as will be explained in greater detail below in connection with FIGS. 5 and 6.

FIG. 5 schematically shows the clamping operation and the widening of the strap clip 16. The initial position, the non-widened position of the strap clip 16, is indicated by solid lines and the widened position by phantom lines in FIG. 5.

The limiting webs 5/3 and 5/4 of the two clamping jaws 1/3 and 1/4, which are of identical design, are provided with a smaller height in this exemplary embodiment. It can be recognized in FIG. 6 that the two clamping jaws 1/3 and 1/4 with their limiting webs 5/3 and 5/4 extend behind the particular clamping tongues 22 and 23 or 21 and end edges, which are located toward the respective face 2/3 and 2/4, are located at a spaced location from the jacket surface 24. At the beginning of the clamping operation, the clamping tongues 21, 22 and 23 are thus supported on the groove bottom 27/3 and 27/4 of the respective receiving groove 3/3 and 3/4, so that essentially only tangential clamping forces act on the clamping tongues 21, 22, 23 at least at the beginning of the clamping operation. It is thus ruled out with certainty that, especially in the case of such short clamping tongues 21, 22, 23, these can “slide” radially up to the respective limiting web 5/3 and 5/4 in the outwardly direction and can bend up, as a result of which deformation of the strap clip 16 is in turn ruled out with certainty.

During the subsequent clamping operation or widening of the strap clip 16 into the position indicated by phantom lines, the clamping tongues 21, 22, 23 perform a pivoting movement around the front edge of the respective limiting edge 5/3 and 5/4, while the front-side support is maintained. After about half to three fourths of the total clamping path, the limiting webs 5/3, 5/4 assume the support of the clamping tongue 21, 22, 23 for the rest of the clamping path. At the same time, the limiting webs 5/3, 5/4 come into linear contact with the outer jacket surface 24, as a result of which this jacket surface 24 is supported radially, especially in the area of the overlapping sections 17, 18 and 20. Due to this radial support in the area of the overlapping sections 17, 18, 20, the strap clip 16 is stabilized during widening and a permanent deformation is thus prevented from occurring.

FIG. 5 shows the end position such that the two clamping jaws 1/3 and 1/4 with their two faces 2/3 and 2/4 are still located at a short distance from each other. FIG. 5 shows clearly that because of the dimensions of the receiving grooves 3/3 and 3/4 of the two clamping jaws 1/3 and 1/4, the pivoting movement of the clamping tongues 21, 22 and 23, which occurs during the clamping operation, can take place without any hindrance, so that deformation is ruled out in this case as well.

FIG. 6 shows as an example that the clamping jaws 1/1 and 1/2 of the type according to the present invention can also be used reliably for the strap clip 8. As is apparent from FIG. 6, these two clamping jaws 1/1 and 1/2 are arranged at spaced locations opposite each other at the two clamping tongues 13 and 14 of the strap clip 8 such that the two clamping tongues 13 and 14 each protrude into a receiving groove 3/1 and 3/2 of the respective clamping jaw 1/1 and 1/2. The shorter limiting web 5/1 and 5/2 extends behind the respective clamping tongue 13 and 14 received. The clamping jaws 13, 14 are also supported on the groove bottom 27/1 and 27/2, respectively, at least at the beginning of the clamping operation. Deformation of the strap clip 8 in the radial direction is thus ruled out with certainty, because essentially only tangential force components act on the clamping tongues 13 and 14.

As is apparent from FIG. 6, the clamping tongues 13 and 14 are received in the receiving grooves 3/1 and 3/2 with a clearance and cannot slip out of the receiving grooves 3/1 and 3/2 by themselves, because the two limiting webs 5/1 and 5/2 extend behind them at a spaced location. The strap clip 8 is widened during the widening or the clamping operation due to the reduction of the distance between the two clamping jaws 1/1 and 1/2 into the position of the clamping jaws 1/1 and 1/2 indicated by phantom lines in FIG. 6, as this is likewise indicated by phantom lines in FIG. 6.

To widen the strap clip 8, the two clamping jaws 1/1 and 1/2 are brought from their position indicated by solid lines into the end position indicated by phantom lines by pressing together in the direction of the arrows 25 and 26. The two clamping tongues 13 and 14 now perform a pivoting movement corresponding to the widening of the strap clip 8 and assume a position in which they extend in parallel to one another on pressing together completely, as this is indicated by phantom lines.

The dimensions of the two receiving grooves 3/1 and 3/2 are selected to be such that this pivoting movement of the two clamping tongues 13 and 14 is essentially not hindered. In this exemplary embodiment, the two clamping jaws 1/1 and 1/2 lie flat on one another with their two faces 2/1 and 2/2 facing each other after the complete widening of the strap clip 8. Because of the set-back arrangement of the lower limiting webs 5/1 and 5/2 in relation to the faces 2/1 and 2/2, the two clamping tongues 13 and 14 are completely accommodated in the intermediate space left between the two limiting webs 5/1 and 5/2 in the end position of the clamping jaws 1/1 and 1/2 in this completely clamped position, so that jamming or deformation of the clamping tongues 13 and 14 is ruled out with certainty.

FIG. 7 shows as an example a complete device 30, which has a spindle drive 31 to perform the clamping movement or to change the clamping jaws 1/5 and 1/6 located opposite each other. In an extremely simple embodiment, this spindle drive 31 comprises a bearing block 32, a threaded block 33 as well as a threaded spindle 34. The clamping jaw 1/5 is stationarily connected to the threaded block 33 in this exemplary embodiment, while the second clamping jaw 1/6 is stationarily in connection with the bearing block 32. The threaded spindle 34 is in turn mounted rotatably and axially nondisplaceably in the bearing block 32. It is easy to imagine that by actuating the threaded spindle 33 via its drive hexagon 35, the threaded block 33 can be adjusted axially along the threaded spindle 34 in the direction of the double arrow 36. The distance between the two clamping jaws 1/5 and 1/6 is thus inevitably changed by this adjustment, so that the clamping movements for widening the respective strap clip 8 and 16, which are shown schematically in FIGS. 5 and 6, can be performed in a simple manner.

FIG. 8 shows another exemplary embodiment of a device, which is designed as a collet chuck 40. This collet chuck 40 has two collet chuck legs 41 and 42, at the outer, free ends of which a clamping jaw 1/7 and 1/8 is arranged stationarily. FIG. 8 shows the closed state of this collet chuck 40. The two clamping jaws 1/7 and 1/8 may be a one-piece part of the respective collet chuck legs 41 and 42 or it may also be fastened replaceably as a separate component at the ends of these collet chuck legs 41 and 42.

In the exemplary embodiment of the collet chuck 40 shown in FIG. 8, the two clamping jaws 1/7 and 1/8 with their receiving grooves 3/7 and 3/8 extend essentially in parallel to the central longitudinal axis 43 of the collet chuck 40 in the closed state of the collet chuck 40 as shown in FIG. 8. Provisions are also made according to the present invention for the clamping jaws 1/7 and 1/8 to be arranged at the ends of the collet chuck legs 41 and 42 extending sloped or at right angles to this central longitudinal axis 43. The clamping jaws 1/7 and 1/8 may also be mounted rotatably at the ends of the collet chuck legs 41 and 42, so that simple adaptation to the particular conditions of use is possible in a simple manner.

A pivoting movement of the clamping jaws 1/7 and 1/8 also inevitably takes place during the clamping in the exemplary embodiment of the collet chuck in FIG. 8, and the lateral slipping out of the corresponding clamping tongues 13, 14 and 21, 22 and 23 from the clamping jaws 1/7 and 1/8 is ruled out with certainty due to the circular limitation of the respective corresponding receiving groove 3/7 and 3/8, especially at the beginning of the clamping operation or the widening of a strap clip 8 or 16 despite this pivoting movement.

While specific embodiments of the invention have been shown and described in detail to illustrate the application of the principles of the invention, it will be understood that the invention may be embodied otherwise without departing from such principles.

What is claimed is:

1. A device for widening a strap clip, the device comprising:
first and second clamping jaws arranged opposite each other in a common path of movement, the distance between the first and second clamping jaws being changed for widening the strap clip wherein the first and second clamping jaws can be brought into engagement each with a radially projecting clamping tongue of the strap clip, each of the first and second clamping jaws have faces facing each other with a receiving groove receiving the free end of the respective clamping tongue and with a receiving groove limiting web located toward the strap clip extending behind the respective clamping tongue during the widening located approximately in parallel to the path of movement and pointing toward the clamping tongue, the limiting web having a height selected to be so small that the respective clamping tongue is supported at the bottom of the receiving groove at least at the beginning of the clamping operation during the widening of the strap clip.

2. A device in accordance with claim 1, wherein the limiting web of each of the first and second clamping jaws extends behind the clamping tongue and is arranged set back in relation to the face.

3. A device in accordance with claim 1, wherein the receiving groove of each of the first and second clamping jaws is limited circumferentially and the receiving groove has a safety web located opposite the limiting web and located in the plane of the face of the respective clamping jaw.

4. A device in accordance with claim 1, wherein a width of the receiving groove corresponds to at most four times a thickness of the clamping tongue to be received.

5. A device in accordance with claim 1, wherein the depth of the receiving groove measured from the face corresponds at most to four times the thickness of the clamping tongue to be received.

6. A device in accordance with claim 1, wherein the clamping jaws are arranged in the end area of the collet legs of a collet chuck.

7. A device in accordance with claim 1, wherein a spindle drive is provided for changing the distance between the two clamping jaws.

8. A device for widening a strap clip, the device comprising:
a first clamping jaw with a face having a receiving groove receiving a free end of a respective clamping tongue and with a receiving groove limiting web located toward the strap clip extending behind the respective clamping tongue during the widening and located approximately in parallel to a path of movement, the limiting web pointing toward the clamping tongue, the limiting web having a height selected to be so small that the respective clamping tongue is supported at the bottom of the receiving groove at least at the beginning of the clamping operation during the widening of the strap clip; and
a second clamping jaw with a second clamping jaw face having a second clamping jaw receiving groove receiving a free end of a respective clamping tongue and with a second clamping jaw receiving groove limiting web located toward the strap clip extending behind the respective clamping tongue during the widening and located approximately in parallel to a path of movement, the second clamping jaw limiting web pointing toward the clamping tongue, the second clamping jaw limiting web having a height selected to be so small that the respective clamping tongue is supported at the bottom of the second clamping jaw receiving groove at least at the beginning of the clamping operation during the widening of the strap clip the second clamping jaw and the first clamping jaw facing each other with the receiving groove and the second clamping jaw receiving groove receiving a free end of the respective clamping tongue.

9. A device and strap clip system, comprising:
a strap clip having radially projecting clamping tongues;
first and second clamping jaws arranged opposite each other in a common path of movement, the distance between the first and second clamping jaws being changed for widening the strap clip wherein the first and second clamping jaws can are brought into engagement each with one of the radially projecting clamping tongues of the strap clip, each of the first and second clamping jaws have faces facing each other with a receiving groove receiving the free end of the respective clamping tongue and with a receiving groove limiting web located toward the strap clip extending behind the respective clamping tongue during the widening located approximately in parallel to the path of movement and pointing toward the clamping tongue, the limiting web having a height selected to be so small that the respective clamping tongue is supported at the bottom of the receiving groove at least at the beginning of the clamping operation during the widening of the strap clip.
